(19) United States
(12) Patent Application Publication
(10) Pub. No.: US 2024/0419134 A1
(43) Pub. Date: Dec. 19, 2024

(54) INTEGRATED RECOMMENDATION METHOD AND SYSTEM FOR SALT-CONTROLLED IRRIGATION AND FERTILIZATION BASED ON KNOWLEDGE GRAPH

(71) Applicant: Shandong Agricultural University, Tai 'an (CN)

(72) Inventors: Tangyuan NING, Tai 'an (CN); Deheng ZHANG, Tai 'an (CN); Zhen LIU, Tai 'an (CN); Geng LI, Tai 'an (CN); Fengbin LI, Tai 'an (CN)

(21) Appl. No.: 18/745,092

(22) Filed: Jun. 17, 2024

(30) Foreign Application Priority Data
Jun. 19, 2023 (CN) 202310724106.5

(51) Int. Cl. G05B 13/02; G06Q 50/02

(52) U.S. Cl. CPC G05B 13/028; G06Q 50/02

(57) ABSTRACT

Provided are an integrated recommendation method and a system for salt-controlled irrigation and fertilization based on a knowledge graph. The method includes following steps: obtaining a vector set of salt-controlled irrigation and fertilization information and a quantitative value set corresponding to the vector set; calculating similarity between the each salt-controlled irrigation and fertilization information according to the quantitative value set; calculating interactive similarity with soil conditions in a salt-controlled irrigation and fertilization case base based on soil salinity, moisture and nutrient status of information of plots with crops located; calculating fusion similarity of the salt-controlled irrigation and fertilization information according to the similarity between the each salt-controlled irrigation and fertilization information and the interactive similarity; and predicting a score of recommendation of the salt-controlled irrigation and fertilization according to the fusion similarity, and completing the recommendation of the salt-controlled irrigation and fertilization according to the score of the recommendation.

### CROSS-REFERENCE TO RELATED APPLICATIONS

This application claims priority to Chinese Patent Application No. 202310724106.5, filed on Jun. 19, 2023, the contents of which are hereby incorporated by reference.

### TECHNICAL FIELD

The disclosure relates to the technical field of agricultural irrigation, and in particular to an integrated recommendation method and a system for salt-controlled irrigation and fertilization based on a knowledge graph.

### BACKGROUND

Rational fertilization is very important in modern agricultural planting. The use of chemical fertilizers has significantly improved crop yield. However, the low utilization rate of fertilizer nutrients, the increase in the cost of inorganic fertilizers, excessive fertilization and unbalanced fertilization have led to increasing soil degradation and environmental pollution, which poses a major threat to food security, ecological security and sustainable agricultural development. Therefore, it is necessary to carry out scientific nutrient management, research and popularize scientific formula fertilization technology, and guide farmers to apply fertilizer scientifically.

Saline-alkali land is an important reserve cultivated land resource in China, and the utilization of saline-alkali land is conducive to ensuring national food security. Under saline-alkali conditions, reasonable salt control is particularly important. Poor salt control will affect crop production and the effect of fertilizer will be difficult to guarantee. Therefore, dynamically obtaining the salt status in the soil and timely recommending irrigation and fertilization schemes will be beneficial for controlling salt, saving water, and improving fertilizer utilization efficiency. This model also plays an important role in preventing secondary salinization and improving fertilizer and water use efficiency in general farmland. It may be seen that an integrated recommendation method and a system for salt-controlled irrigation and fertilization based on a knowledge graph have broad adaptability and application scenarios.

At present, the research on fertilization planning methods may be mainly divided into three categories, namely, methods based on mathematical models, methods based on knowledge and methods based on artificial intelligence models. The methods based on mathematical models may get the fertilization amount by inputting the relevant variables of crops and soil into the mathematical models, so suggestions on fertilizer varieties, fertilization methods, and other aspects are usually not provided. On the other hand, it is also a common method to make fertilization plan by using authoritative expert knowledge in the field. This kind of method may make fertilization plan by extracting fertilization rules from knowledge, and usually may provide suggestions on fertilization amount, fertilization technology, fertilizer ratio and so on. In recent years, with the great improvement of computing power, artificial intelligence models have made good progress in fertilization recommendation. Such models may get high-precision fertilization recommendation results by inputting some easily available field information. From the above situation, it may be seen that the research on the formulation method of crop fertilization plan is not sufficient at present, and there is no integrated recommendation method and system for salt-controlled irrigation and fertilization based on knowledge graph.

Therefore, how to solve the above problems is urgently needed by the technicians in this field.

### SUMMARY

In view of this, the disclosure provides an integrated recommendation method and a system for salt-controlled irrigation and fertilization based on a knowledge graph, so as to solve the problems raised in the prior art.

In order to achieve the above objective, the disclosure adopts a following technical scheme.

An integrated recommendation method for salt-controlled irrigation and fertilization based on a knowledge graph includes following steps:
S1, vectorizing each salt-controlled irrigation and fertilization information in a knowledge graph of recommendation of the salt-controlled irrigation and fertilization to obtain a vector set of the salt-controlled irrigation and fertilization information and a quantitative value set corresponding to the vector set;
S2, calculating similarity between the each salt-controlled irrigation and fertilization information according to the quantitative value set in the knowledge graph;
S3, calculating interactive similarity with soil conditions in a salt-controlled irrigation and fertilization case base based on soil conditions of information of plots with crops located;
S4, calculating fusion similarity of the salt-controlled irrigation and fertilization information according to the similarity between the each salt-controlled irrigation and fertilization information and the interactive similarity; and
S5, predicting a score of the recommendation of the salt-controlled irrigation and fertilization according to the fusion similarity, and completing the recommendation of the salt-controlled irrigation and fertilization according to the score of the recommendation.

Optionally, calculating the similarity between the salt-controlled irrigation and fertilization information specifically includes: performing information retrieval for the each salt-controlled irrigation and fertilization information, obtaining classification results of the salt-controlled irrigation and fertilization information according to retrieval results, and matching the similarity between the each salt-controlled irrigation and fertilization information in combination with the classification results of the salt-controlled irrigation and fertilization information and fertility situation.

Optionally, the information of plots with crops located includes plot location data, soil type data, soil salinity, moisture and nutrient data, crop information, administrative region data and climate data.

Optionally, based on geographical information system (GIS) technology, spatial information are collected, managed, analyzed, displayed and output, and an expert system of salt-controlled irrigation and fertilization is constructed by integrating the salt-controlled irrigation and fertilization information and the information of plots with crops located, and the information retrieval for the each salt-controlled irrigation and fertilization information is performed based on the expert system of salt-controlled irrigation and fertilization.

Optionally, the method also includes updating and revising the knowledge graph according to a final recommendation of the salt-controlled irrigation and fertilization, specifically including following steps: according to obtained final salt-controlled irrigation and fertilization recommendation information, establishing a dictionary and an index through data preprocessing, selecting different models to train data, obtaining a model reaching an evaluation indicator, determining an evaluation indicator, and evaluating prediction results under different models;

according to the knowledge graph of the recommendation of the salt-controlled irrigation and fertilization, automatically selecting entities and relationships associated with an incomplete triplet, and obtaining an original input of the model through data processing, and putting the original input into a predetermined model to obtain output results; and

importing the output results into the knowledge graph through information extraction and information integration, and realizing an effect of automatically completing and updating the knowledge graph.

Optionally, the salt control recommendation includes making recommendation on a salt migration law through reasoning based on the knowledge graph, and making recommendation on a time, an amount and a method of irrigation salt control according to future weather.

Optionally, irrigation recommendation includes making recommendation on salt-controlled irrigation and water-storage irrigation through the reasoning based on the knowledge graph, and finally making recommendation on salt-controlled, water-saving and high crop yield coordination.

Optionally, the recommendation of the salt-controlled irrigation and fertilization includes making recommendation on fertilization principles, fertilization opportunities, fertilizer types, fertilizer dosage and fertilization methods in different stages of crop growth through the reasoning based on the knowledge graph.

A fertilization recommendation system based on a knowledge graph includes:
a salt-controlled irrigation and fertilization information vectorization module used for vectorizing each salt-controlled irrigation and fertilization information in a knowledge graph of recommendation of salt-controlled irrigation and fertilization to obtain a vector set of the salt-controlled irrigation and fertilization information and a quantitative value set corresponding to the vector set;
a similarity calculation module used for calculating similarity between the each salt-controlled irrigation and fertilization information according to the quantitative value set in the knowledge graph;
an interactive similarity calculation module used for calculating interactive similarity with soil conditions in a salt-controlled irrigation and fertilization case base based on soil conditions of information of plots with crops located;
a fusion similarity calculation module used for calculating fusion similarity of the salt-controlled irrigation and fertilization information according to the similarity between the each salt-controlled irrigation and fertilization information and the interactive similarity; and
a salt-controlled irrigation and fertilization recommendation module used for predicting a score of the recommendation of the salt-controlled irrigation and fertilization according to the fusion similarity, and completing the recommendation of the salt-controlled irrigation and fertilization according to a score of the recommendation.

According to the technical scheme, compared with the prior art, the disclosure provides an integrated recommendation method and a system for salt-controlled irrigation and fertilization based on a knowledge graph, which has following beneficial effects.

Firstly, the fertilization recommendation method according to the disclosure may not only improve the utilization rate of fertilizer, reduce the loss of fertilizer, and avoid the adverse impact of excessive use of fertilizer on the environment, but also improve the crop yield.

Secondly, the disclosure may further optimize the fertilization model and improve the fertilization parameters according to the data of later fertilizer efficiency test, new fertilization method and crop yield, and has characteristics of continuous optimization and improvement, and is more suitable for the rapidly developing intelligent agricultural fertilization method.

### BRIEF DESCRIPTION OF THE DRAWINGS

In order to clearly explain the embodiment of the disclosure or the technical scheme in the prior art, the drawings needed in the description of the embodiment or the prior art will be briefly introduced below. Obviously, the drawings in the following description are only the embodiment of the disclosure, and other drawings may be obtained according to the provided drawings without creative labour for ordinary people in the field.

FIG. 1 is a schematic flow diagram of the disclosure.

FIG. 2 is a schematic structural diagram of the disclosure.

### DETAILED DESCRIPTION OF THE EMBODIMENTS

In the following, the technical scheme in the embodiment of the disclosure will be clearly and completely described with reference to the attached drawings. Obviously, the described embodiments are only a part of the embodiments of the disclosure, but not all of the embodiments. Based on the embodiments in the disclosure, all other embodiments obtained by ordinary technicians in the field without creative labour belong to the protection scope of the disclosure.

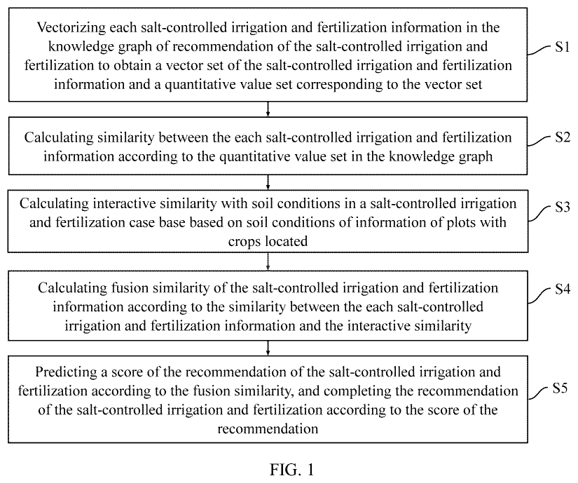

An embodiment of the disclosure discloses an integrated recommendation method for salt-controlled irrigation and fertilization based on a knowledge graph, as shown in FIG. 1, including following steps:
S1, vectorizing each salt-controlled irrigation and fertilization information in a knowledge graph of recommendation of the salt-controlled irrigation and fertilization to obtain a vector set of the salt-controlled irrigation and fertilization information and a quantitative value set corresponding to the vector set;
S2, calculating similarity between the each salt-controlled irrigation and fertilization information according to the quantitative value set in the knowledge graph;
S3, calculating interactive similarity with soil conditions in a salt-controlled irrigation and fertilization case base based on soil conditions of information of plots with crops located;
S4, calculating fusion similarity of the salt-controlled irrigation and fertilization information according to the similarity between the each salt-controlled irrigation and fertilization information and the interactive similarity; and
S5, predicting a score of the recommendation of the salt-controlled irrigation and fertilization according to the fusion similarity, and completing the recommendation of the salt-controlled irrigation and fertilization according to the score of the recommendation.

Further, in the S2, calculating the similarity between the salt-controlled irrigation and fertilization information specifically includes: performing information retrieval for the each salt-controlled irrigation and fertilization information, obtaining classification results of the salt-controlled irrigation and fertilization information according to retrieval results, and matching the similarity between the each salt-controlled irrigation and fertilization information in combination with the classification results of the salt-controlled irrigation and fertilization information and fertility situation.

Further, in the S3, the information of plots with crops located includes plot location data, soil type data, soil nutrient data, crop information, administrative region data and climate data.

Further, based on GIS technology, spatial information are collected, managed, analyzed, displayed and output, and an expert system of salt-controlled irrigation and fertilization is constructed by integrating the salt-controlled irrigation and fertilization information and the information of plots with crops located, and based on the expert system of salt-controlled irrigation and fertilization, the each salt-controlled irrigation and fertilization information is retrieved.

Further, the method also includes updating and revising the knowledge graph according to a final recommendation of the salt-controlled irrigation and fertilization, specifically including following steps: according to obtained final salt-controlled irrigation and fertilization recommendation information, establishing a dictionary and an index through data preprocessing, selecting different models to train the data, obtaining a model reaching an evaluation indicator, determining an evaluation indicator, and evaluating prediction results under different models;
according to the knowledge graph of the recommendation of the salt-controlled irrigation and fertilization, automatically selecting entities and relationships associated with an incomplete triplet, and obtaining an original input of the model through data processing, and putting the original input into a predetermined model to obtain output results; and
importing the output results into the knowledge graph through information extraction and information integration, and realizing an effect of automatically completing and updating the knowledge graph.

Further, in the disclosure, the missing information may be supplemented by link prediction technology. Specifically, according to representation vectors representing the entities and the relationships in the learned map, the rice variety to be planted is taken as a head entity, and for each missing relationship, a scoring function is calculated by taking each entity in the map as a tail entity. A closest tail entity is selected as a prediction result of the missing part of a fertilization scheme. Finally, a predicted fertilization scheme and the existing fertilization scheme in the map are used as recommended results.

Further, in the S5, salt control recommendation includes making recommendation on a salt migration law through reasoning based on the knowledge graph, and making recommendation on a time, an amount and a method of irrigation salt control according to future weather.

Irrigation recommendation includes making recommendation on salt-controlled irrigation and water-storage irrigation through the reasoning based on the knowledge graph, and finally making recommendation on salt-controlled, water-saving and high crop yield coordination.

The recommendation of the salt-controlled irrigation and fertilization includes making recommendation on fertilization principles, fertilization opportunities, fertilizer types, fertilizer dosage and fertilization methods in different stages of crop growth through the reasoning based on the knowledge graph.

Taking saline-alkali land as an example, firstly, a data acquisition station is used to collect the salt content of the saline-alkali land, where the data acquisition station includes a solar energy mechanism, a data terminal and a plurality of data collectors; the solar energy mechanism is used to convert solar energy into electric energy for storage and provide electric energy for the data collectors and the data terminal, the plurality of data collectors are distributed in the detection site according to the specific conditions of the land, and the growth of plants and soil water content information in the detection site are collected by the data collectors, and the data terminal is used to centrally process the information collected by all the data collectors;

combining the collected information and the quantitative value set in the knowledge graph, similarity between each saline-alkali land fertilization improvement information is calculated; based on the specific situation of the saline-alkali land, interactive similarity with the soil conditions in a fertilization case base is calculated; according to the similarity between the each saline-alkali land improvement information and the interactive similarity, fusion similarity of the saline-alkali land improvement information is calculated; and according to the fusion similarity, specific improvement methods of the saline-alkali land are recommended.

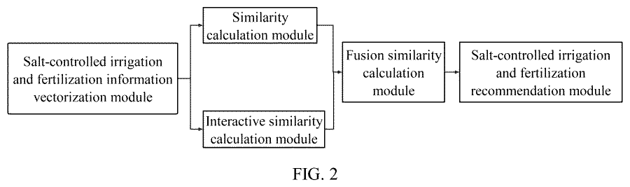

Corresponding to the method shown in FIG. 1, the disclosure also discloses a fertilization recommendation system based on a knowledge graph for realizing the method shown in FIG. 1, with a specific structure as shown in FIG. 2, including:
a salt-controlled irrigation and fertilization information vectorization module used for vectorizing each salt-controlled irrigation and fertilization information in a knowledge graph of recommendation of salt-controlled irrigation and fertilization to obtain a vector set of the salt-controlled irrigation and fertilization information and a quantitative value set corresponding to the vector set;
a similarity calculation module used for calculating similarity between the each salt-controlled irrigation and fertilization information according to the quantitative value set in the knowledge graph;
an interactive similarity calculation module used for calculating interactive similarity with soil conditions in a salt-controlled irrigation and fertilization case base based on soil conditions of information of plots with crops located;
a fusion similarity calculation module used for calculating fusion similarity of the salt-controlled irrigation and fertilization information according to the similarity between the each salt-controlled irrigation and fertilization information and the interactive similarity; and
a salt-controlled irrigation and fertilization recommendation module used for predicting a score of the recommendation of the salt-controlled irrigation and fertilization according to the fusion similarity, and completing the recommendation of the salt-controlled irrigation and fertilization according to the score of the recommendation.

Finally, this embodiment also discloses a computer storage medium, where a computer program is stored on the computer storage medium, and when the computer program is executed by a processor, any step of the integrated recommendation method for salt-controlled irrigation and fertilization based on the knowledge graph is realized. Different from other embodiments, the same and similar parts between each embodiment may only be referred to each other. As for the device disclosed in the embodiment, because the device corresponds to the method disclosed in the embodiment, the description is relatively simple, and the relevant points may only be described in the method part.

The above description of the disclosed embodiments enables those skilled in the art to make or use the disclosure. Many modifications to these embodiments will be obvious to those skilled in the art, and the general principles defined in the disclosure may be implemented in other embodiments without departing from the spirit or scope of the disclosure. Therefore, the disclosure is not to be limited to the embodiments shown in the disclosure, but is to be accorded the widest scope consistent with the principles and novel features disclosed in the disclosure.

What is claimed is:

1. An integrated recommendation method for salt-controlled irrigation and fertilization based on a knowledge graph, comprising following steps:
S1, vectorizing each salt-controlled irrigation and fertilization information in the knowledge graph of recommendation of the salt-controlled irrigation and fertilization to obtain a vector set of the salt-controlled irrigation and fertilization information and a quantitative value set corresponding to the vector set;
S2, calculating similarity between the each salt-controlled irrigation and fertilization information according to the quantitative value set in the knowledge graph;
S3, calculating interactive similarity with soil conditions in a salt-controlled irrigation and fertilization case base based on soil conditions of information of plots with crops located;
S4, calculating fusion similarity of the salt-controlled irrigation and fertilization information according to the similarity between the each salt-controlled irrigation and fertilization information and the interactive similarity; and
S5, predicting a score of the recommendation of the salt-controlled irrigation and fertilization according to the fusion similarity, and completing the recommendation of the salt-controlled irrigation and fertilization according to the score of the recommendation.

2. The integrated recommendation method for the salt-controlled irrigation and fertilization based on the knowledge graph according to claim 1, wherein calculating the similarity between the salt-controlled irrigation and fertilization information specifically comprises: performing information retrieval for the each salt-controlled irrigation and fertilization information, obtaining classification results of the salt-controlled irrigation and fertilization information according to retrieval results, and matching the similarity between the each salt-controlled irrigation and fertilization information in combination with the classification results of the salt-controlled irrigation and fertilization information and fertility situation.

3. The integrated recommendation method for the salt-controlled irrigation and fertilization based on the knowledge graph according to claim 1, wherein the information of plots with crops located comprises plot location data, soil type data, soil salinity, moisture and nutrient data, crop information, administrative region data and climate data.

4. The integrated recommendation method for the salt-controlled irrigation and fertilization based on the knowledge graph according to claim 2, wherein based on GIS technology, spatial information are collected, managed, analyzed, displayed and output, and an expert system of the salt-controlled irrigation and fertilization is constructed by integrating the salt-controlled irrigation and fertilization information and the information of plots with crops located, and the information retrieval for the each salt-controlled irrigation and fertilization information is performed based on the expert system of the salt-controlled irrigation and fertilization.

5. The integrated recommendation method for the salt-controlled irrigation and fertilization based on the knowledge graph according to claim 1, further comprising updating and revising the knowledge graph according to a final recommendation of the salt-controlled irrigation and fertilization, specifically comprising following steps: according to obtained final salt-controlled irrigation and fertilization recommendation information, establishing a dictionary and an index through data preprocessing, selecting different models to train data, obtaining a model reaching a predetermined indicator, determining an evaluation indicator, and evaluating prediction results under different models;
according to the knowledge graph of the recommendation of the salt-controlled irrigation and fertilization, automatically selecting entities and relationships associated with an incomplete triplet, and obtaining an original input of the model through data processing, and putting the original input into a predetermined model to obtain output results; and
importing the output results into the knowledge graph through information extraction and information integration, and realizing an effect of automatically completing and updating the knowledge graph.

6. The integrated recommendation method for the salt-controlled irrigation and fertilization based on the knowledge graph according to claim 1, wherein salt control recommendation comprises making recommendation on a salt migration law through reasoning based on the knowledge graph, and making recommendation on a time, an amount and a method of irrigation salt control according to future weather.

7. The integrated recommendation method for the salt-controlled irrigation and fertilization based on the knowledge graph according to claim 1, wherein irrigation recommendation comprises making recommendation on salt-controlled irrigation and water-storage irrigation through the reasoning based on the knowledge graph, and finally making recommendation on salt-controlled, water-saving and high crop yield coordination.

8. The integrated recommendation method for the salt-controlled irrigation and fertilization based on the knowledge graph according to claim 1, wherein the recommendation of the salt-controlled irrigation and fertilization comprises making recommendation on fertilization principles, fertilization opportunities, fertilizer types, fertilizer dosage and fertilization methods in different stages of crop growth through the reasoning based on the knowledge graph.

9. A fertilization recommendation system based on a knowledge graph, comprising:
a salt-controlled irrigation and fertilization information vectorization module used for vectorizing each salt-controlled irrigation and fertilization information in a knowledge graph of recommendation of salt-controlled irrigation and fertilization to obtain a vector set of the salt-controlled irrigation and fertilization information and a quantitative value set corresponding to the vector set;
a similarity calculation module used for calculating similarity between the each salt-controlled irrigation and fertilization information according to the quantitative value set in the knowledge graph;
an interactive similarity calculation module used for calculating interactive similarity with soil conditions in a salt-controlled irrigation and fertilization case base based on soil conditions of information of plots with crops located;
a fusion similarity calculation module used for calculating fusion similarity of the salt-controlled irrigation and fertilization information according to the similarity between the each salt-controlled irrigation and fertilization information and the interactive similarity; and
a salt-controlled irrigation and fertilization recommendation module used for predicting a score of the recommendation of the salt-controlled irrigation and fertilization according to the fusion similarity, and completing the recommendation of the salt-controlled irrigation and fertilization according to the score of the recommendation.
